(19) United States
(12) Patent Application Publication
(10) Pub. No.: US 2017/0147110 A1
(43) Pub. Date: May 25, 2017

(54) IPS ON-CELL TOUCH DISPLAY PANEL AND MANUFACTURING METHOD THEREOF

(71) Applicant: Shenzhen China Star Optoelectronics Technology Co. Ltd., Shenzhen City (CN)

(72) Inventor: Xiangyang Xu, Shenzhen City (CN)

(21) Appl. No.: 14/777,742

(22) PCT Filed: Jul. 23, 2015
(86) PCT No.: PCT/CN2015/084872

§ 371 Date: Sep. 16, 2015

(30) Foreign Application Priority Data
Jun. 18, 2015 (CN) 201510342659.X

(51) Int. Cl. G06F 3/041; G02F 1/1343; G02F 1/1339; G02F 1/1368; G02F 1/1337; G02F 1/1362; G02F 1/1333; G02F 1/1335

(52) U.S. Cl. CPC G06F 3/0412; G02F 1/13338; G02F 1/134363; G02F 1/133514; G02F 1/13439; G02F 1/1368; G02F 1/1337; G02F 1/133345; G02F 1/136286; G02F 1/133512; G02F 1/13394; G02F 2001/136222; G02F 2201/123; G02F 2201/121; G06F 2203/04103

(57) ABSTRACT

The present invention provides an IPS on-cell touch display panel and a manufacturing method thereof. The IPS on-cell touch display panel includes an array color-filter substrate (1) and an upper substrate (3) opposite to each other, a liquid crystal layer (5) interposed between the array color-filter substrate (1) and the upper substrate (3), and a touch electrode (7) arranged on a surface of the upper substrate (3) that is distant from the liquid crystal layer (5). The array color-filter substrate (1) includes a TFT (T), a pixel electrode (18), a comb-like common electrode (20), and a color filter photoresist (17) and combine a function of a TFT array and a filtering function of a color filter. The upper substrate (3) includes only an upper backing plate (31) and an upper alignment film (33) arranged on a surface of the upper backing plate (31) that is adjacent to the liquid crystal layer (5). The touch electrode (7) is arranged on a surface of the upper backing plate (3) that is distant from the liquid crystal layer (5). The touch electrode (7) is subjected to high temperature annealing treatment so as to have reduced impedance and increased touch sensitivity.

### BACKGROUND OF THE INVENTION

1. Field of the Invention

The present invention relates to the field of display technology, and in particular to an in-plane switching (IPS) on-cell touch display panel and a manufacturing method thereof.

2. The Related Arts

With the rapid process of the display technology, touch display panels have been widely accepted and used by people. For example, intelligent phones and tablet computers both involve the use of touch display pane. The touch display panel is formed by applying the embedding touch technology to combine a touch panel and a liquid crystal display panel with each other as a unit with the functionality of the touch panel embedded in the liquid crystal display panel to make the liquid crystal display panel to simultaneously possess the functions of displaying and touch control/input.

The liquid crystal display panels are generally made up of a color filter (CF) substrate, a thin-film transistor (TFT) array substrate, and a liquid crystal layer interposed between the two substrates, of which the principle of operation is to control liquid crystal molecule to rotate by applying a driving voltage to the two glass substrates in order to refract out light from a backlight module to generate an image. According to the different ways of alignment of the liquid crystal, the liquid crystal display panels of the main stream market can be classified in several types: vertical alignment (VA), twisted nematic (TN) or super twisted nematic (STN), in-plane switching (IPS), and fringe field switching (FFS).

In the IPS liquid crystal display panel, the liquid crystal molecule are aligned in parallel with substrate surfaces and the rotation of the liquid crystal molecules is controlled by applying a lateral electrical field to the liquid crystal layer. As shown in FIG. 1, a conventional IPS liquid crystal display panel generally comprises a TFT substrate 100 and a CF substrate 200 that are arranged opposite to each other and a liquid crystal layer 300 interposed between the two. The TFT substrate 100 comprises: a lower backing plate 110, a gate terminal 121, a scan line 122, a gate insulation layer 130, a semiconductor layer 140, source/drain terminals 151, a data line 152, an indium tin oxide (ITO) pixel electrode 160, an insulation protection layer 170, a comb-like ITO common electrode 180, and a lower alignment film 190. The CF substrate 200 comprises: an upper backing plate 210, a color filter photoresist 220, a back matrix 230, a photo spacer 240, and an upper alignment film 250. To provide electromagnetic protection to the conventional IPS liquid crystal display panel. A layer of ITO transparent electrode 260 is arranged on the entirety of a surface of the upper backing plate 210 of the CF substrate 200 that is distant from the liquid crystal layer 3.

The touch display panels can be classified, according to techniques of detection applied, four types, which are resistive type, capacitive type, optical type, and acoustic wave type. The main stream of the touch technology is the capacitive type, which is further divided into self-capacitance type and mutual capacitance type. The capacitive touch display panels that are currently available in the market are primarily the mutual capacitance type. An advantage of the mutual capacitance type is the capability of multiple point touch control. The touch display panels can be further classified, according to the structures thereof, into on-cell type, in-cell type, and external mounting type, among which the in-cell type possess advantages of low cost, being ultra-thin, and narrowed frame and are generally applied in high-end touch products. However, due to factors, such as higher technical difficulty and being susceptible to signal interference, the sensitivity of the in-cell touch control is generally poor. The touch display panels that are most widely used in the current market are the external mounting type. Advantages of the external mounting type include high sensitivity and fast response speed, but there are also disadvantages including high cost and limitation on product thinning. The on-cell types possesses the advantages of both the external mounting type and the in-cell type and thus has increased sensitivity and allows for reduction of panel thickness. However, a manufacturing process of an on-cell touch display panel allows a transparent electrode of indium tin oxide (ITO) that is provided for making a touch control circuit to be coated on a panel surface after boxing of liquid crystal. ITO has a limited annealing temperature so that the impedance can hardly be lowered, leading to a constrain to the increase of touch sensitivity.

### SUMMARY OF THE INVENTION

An object of the present invention is to provide an in-plane switching (IPS) on-cell touch display panel, which comprises a touch electrode having a reduced impedance and increased touch sensitivity.

Another object of the present invention is to provide a manufacturing method of an IPS on-cell touch display panel, which reduces the impedance of a touch electrode and increases touch sensitivity.

To achieve the above objects, the present invention provides an IPS on-cell touch display panel, which comprises an array color-filter substrate, an upper substrate opposite to the array color-filter substrate, a liquid crystal layer interposed between the array color-filter substrate and the upper substrate, and a touch electrode arranged on a surface of the upper substrate that is distant from the liquid crystal layer;

the array color-filter substrate comprising a thin-film transistor (TFT), a pixel electrode, a comb-like common electrode, and a color filter photoresist and combining a function of a TFT array and a filtering function of a color filter;

the upper substrate comprising only an upper backing plate and an upper alignment film arranged on a surface of the upper backing plate that is adjacent to the liquid crystal layer;

the touch electrode being arranged on a surface of the upper backing plate that is distant from the liquid crystal layer, the touch electrode being subjected to high temperature annealing treatment.

The array color-filter substrate comprises a lower backing plate, a gate terminal and a scan line arranged on the lower backing plate, a gate insulation layer arranged on the gate terminal, the scan line, and the lower backing plate, an island-like semiconductor layer arranged on the gate insulation layer and located above the gate terminal, source/drain terminals arranged on the gate insulation layer and respectively in contact engagement with two opposite side portions of the island-like semiconductor layer, a data line arranged on the gate insulation layer, an insulation protection layer arranged on the source/drain terminals, the data line, and the gate insulation layer, color filter photoresist arranged on the insulation protection layer, a pixel electrode arranged on the color filter photoresist and in contact engagement with a portion of the source/drain terminals, an insulation layer arranged on the pixel electrode and the color filter photoresist, a comb-like common electrode arranged on the insulation layer and opposite to the pixel electrode, a black matrix arranged on the insulation layer, a photo spacer arranged on the black matrix, and a lower alignment film covering the insulation layer, the common electrode, the black matrix, and the photo spacer;

the gate terminal, the island-like semiconductor layer, and the source/drain terminals collectively constituting the TFT.

The touch electrode is formed of a material of indium tin oxide (ITO).

The pixel electrode and the common electrode are each formed of a material of ITO.

The upper backing plate and the lower backing plate are each a glass plate.

The present invention also provides an IPS on-cell touch display panel, which comprises an array color-filter substrate, an upper substrate opposite to the array color-filter substrate, a liquid crystal layer interposed between the array color-filter substrate and the upper substrate, and a touch electrode arranged on a surface of the upper substrate that is distant from the liquid crystal layer;

the array color-filter substrate comprising a TFT, a pixel electrode, a comb-like common electrode, and a color filter photoresist and combining a function of a TFT array and a filtering function of a color filter;

the upper substrate comprising only an upper backing plate and an upper alignment film arranged on a surface of the upper backing plate that is adjacent to the liquid crystal layer;

the touch electrode being arranged on a surface of the upper backing plate that is distant from the liquid crystal layer, the touch electrode being subjected to high temperature annealing treatment;

wherein the array color-filter substrate comprises a lower backing plate, a gate terminal and a scan line arranged on the lower backing plate, a gate insulation layer arranged on the gate terminal, the scan line, and the lower backing plate, an island-like semiconductor layer arranged on the gate insulation layer and located above the gate terminal, source/drain terminals arranged on the gate insulation layer and respectively in contact engagement with two opposite side portions of the island-like semiconductor layer, a data line arranged on the gate insulation layer, an insulation protection layer arranged on the source/drain terminals, the data line, and the gate insulation layer, color filter photoresist arranged on the insulation protection layer, a pixel electrode arranged on the color filter photoresist and in contact engagement with a portion of the source/drain terminals, an insulation layer arranged on the pixel electrode and the color filter photoresist, a comb-like common electrode arranged on the insulation layer and opposite to the pixel electrode, a black matrix arranged on the insulation layer, a photo spacer arranged on the black matrix, and a lower alignment film covering the insulation layer, the common electrode, the black matrix, and the photo spacer;

the gate terminal, the island-like semiconductor layer, and the source/drain terminals collectively constituting the TFT;

wherein the touch electrode is formed of a material of ITO; and

wherein the pixel electrode and the common electrode are each formed of a material of ITO.

The present invention further provides a manufacturing method of an IPS on-cell touch display panel, which comprises the following steps:

(1) providing an upper backing plate and coating an alignment solution on a surface of the upper backing plate to form an upper alignment film, thereby forming an upper substrate;

(2) forming a touch electrode on a surface of the upper backing plate that is opposite to the alignment film and subjecting the touch electrode to high temperature annealing treatment so as to reduce impedance of the touch electrode;

(3) providing an array color-filter substrate, wherein the array color-filter substrate comprises a TFT, a pixel electrode, a comb-like common electrode, and a color filter photoresist and combines a function of a TFT array and a filtering function of a color filter; and

(4) laminating the array color-filter substrate and the upper substrate together in such a way that the upper alignment film faces the array color-filter substrate and filling liquid crystal between the array color-filter substrate and the upper substrate to form a liquid crystal layer.

Step (2) further comprises, after the high temperature annealing treatment of the touch electrode, coating an organic protection film to cover the touch electrode; and

step (4) further comprises removing the organic protection film.

The organic protection film is formed of a material of polyimide or photoresist and has a thickness of 3-5 μm.

The array color-filter substrate comprises a lower backing plate, a gate terminal and a scan line arranged on the lower backing plate, a gate insulation layer arranged on the gate terminal, the scan line, and the lower backing plate, an island-like semiconductor layer arranged on the gate insulation layer and located above the gate terminal, source/drain terminals arranged on the gate insulation layer and respectively in contact engagement with two opposite side portions of the island-like semiconductor layer, a data line arranged on the gate insulation layer, an insulation protection layer arranged on the source/drain terminals, the data line, and the gate insulation layer, color filter photoresist arranged on the insulation protection layer, a pixel electrode arranged on the color filter photoresist and in contact engagement with a portion of the source/drain terminals, an insulation layer arranged on the pixel electrode and the color filter photoresist, a comb-like common electrode arranged on the insulation layer and opposite to the pixel electrode, a black matrix arranged on the insulation layer, a photo spacer arranged on the black matrix, and a lower alignment film covering the insulation layer, the common electrode, the black matrix, and the photo spacer; and the gate terminal, the island-like semiconductor layer, and the source/drain terminals collectively constitute the TFT.

The touch electrode, the pixel electrode, and the common electrode are each formed of a material of ITO; and the upper backing plate and the lower backing plate are each a glass plate.

The efficacy of the present invention is that the present invention provides an IPS on-cell touch display panel, which comprises an array color-filter substrate that combines a function of a TFT array and a filtering function of a color filter and comprises an upper substrate that comprises only a backing plate and an alignment film with a touch electrode arranged on a surface of the upper backing plate that is distant from a liquid crystal layer and the touch electrode has been subjected to high temperature annealing treatment so that the impedance of the touch electrode is reduced and the touch sensitivity is increased. The present invention provides a manufacturing method of an IPS on-cell touch display panel, in which before an array color-filter substrate and an upper substrate are laminated together and a liquid crystal layer is formed, a touch electrode is first formed on a surface of an upper backing plate of an upper substrate that is distant from the liquid crystal layer and the touch electrode is subjected to high temperature annealing treatment so as to reduce the impedance of the touch electrode and increase the touch sensitivity.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a schematic view showing a structure of a conventional in-plane switching (IPS) liquid crystal display panel;

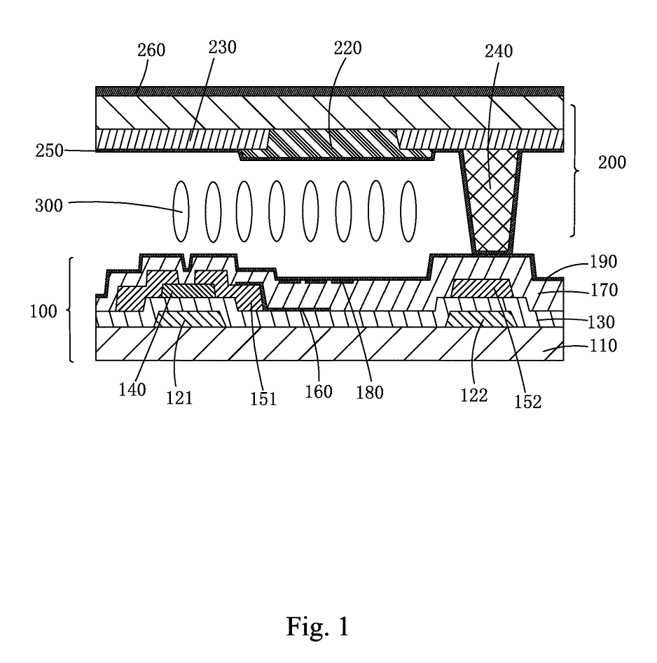

FIG. 2 is a schematic view showing a structure of an IPS on-cell touch display panel according to the present invention; and

FIG. 3 is a flow chart illustrating a manufacturing method of an IPS on-cell touch display panel according to the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

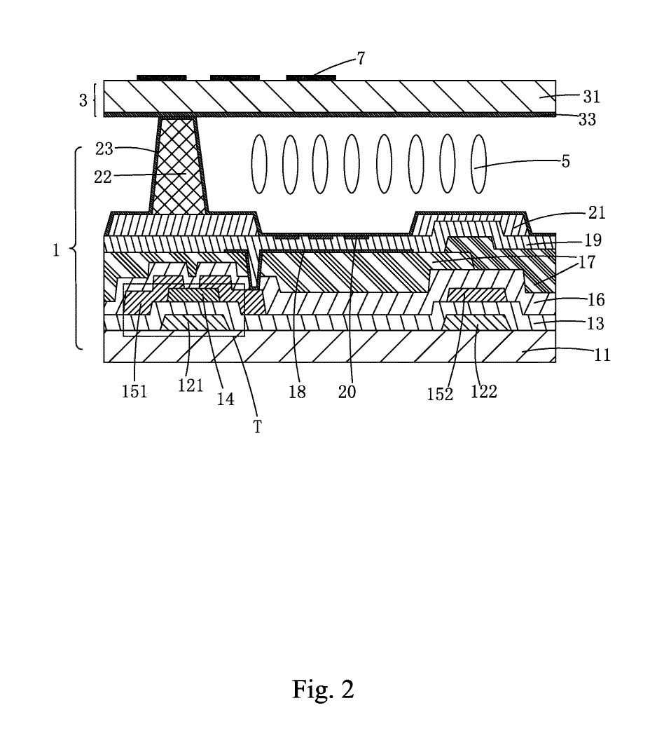

Referring to FIG. 2, firstly, the present invention provides an in-plane switching (IPS) on-cell touch display panel, which comprises an array color-filter substrate 1, an upper substrate 3 opposite to the array color-filter substrate 1, a liquid crystal layer 5 interposed between the array color-filter substrate 1 and the upper substrate 3, and a touch electrode 7 arranged on a surface of the upper substrate 3 that is distant from the liquid crystal layer 5.

Specifically, the array color-filter substrate 1 combines a function of a thin-film transistor (TFT) array and a filtering function of a color filter and comprises a lower backing plate 11, a gate terminal 121 and a scan line 122 arranged on the lower backing plate 11, a gate insulation layer 13 arranged on the gate terminal 121, the scan line 122, and the lower backing plate 11, an island-like semiconductor layer 14 arranged on the gate insulation layer 13 and located above the gate terminal 121, source/drain terminals 151 arranged on the gate insulation layer 13 and respectively in contact engagement with two opposite side portions of the island-like semiconductor layer 14, a data line 152 arranged on the gate insulation layer 13, an insulation protection layer 16 arranged on the source/drain terminals 151, the data line 152, and the gate insulation layer 13, color filter photoresist 17 arranged on the insulation protection layer 16, a pixel electrode 18 arranged on the color filter photoresist 17 and in contact engagement with a portion of the source/drain terminals 151, an insulation layer 19 arranged on the pixel electrode 18 and the color filter photoresist 17, a comb-like common electrode 20 arranged on the insulation layer 19 and opposite to the pixel electrode 18, a black matrix 21 arranged on the insulation layer 19, a photo spacer 22 arranged on the black matrix 21, and a lower alignment film 23 covering the insulation layer 19, the common electrode 20, the black matrix 21, and the photo spacer 22. The gate terminal 121, the island-like semiconductor layer 14, and the source/drain terminals 151 collectively constitute a thin-film transistor T.

The upper substrate 3 comprises only an upper backing plate 31 and an upper alignment film 33 arranged on a surface of the upper backing plate 31 that is adjacent to the liquid crystal layer 5.

The touch electrode 7 is arranged on a surface of the upper backing plate 3 that is distant from the liquid crystal layer 5. The touch electrode 7 has been subjected to high temperature annealing treatment so that impedance of the touch electrode 7 is reduced and touch sensitivity is increased.

Further, the touch electrode 7 is preferably formed of a material of ITO.

The pixel electrode 18 and the common electrode 20 are preferably each formed of a material of ITO.

The upper backing plate 31 and the lower backing plate 11 are both glass plates.

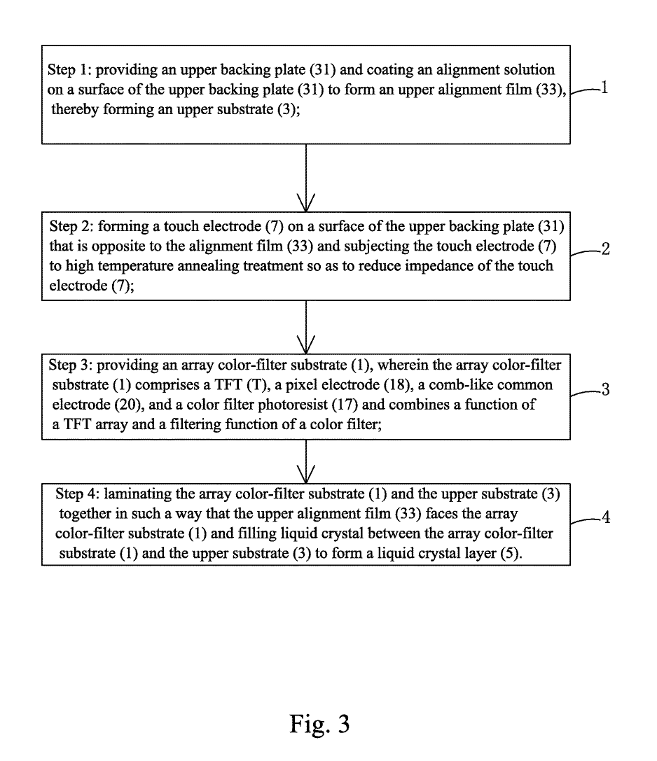

Referring to FIG. 3 in combination with FIG. 2, the present invention further provides a manufacturing method of an IPS on-cell touch display panel, which comprises the following steps:

Step 1: providing an upper backing plate 31 and coating an alignment solution on a surface of the upper backing plate 31 to form an upper alignment film 33, thereby forming an upper substrate 3.

Specifically, the upper backing plate 31 is a glass plate.

Step 2: forming a touch electrode 7 on a surface of the upper backing plate 31 that is opposite to the alignment film 33 and subjecting the touch electrode 7 to high temperature annealing treatment so as to reduce impedance of the touch electrode 7.

Specifically, the touch electrode 7 is preferably formed of a material of ITO.

Moreover, Step 2 further comprises, after the high temperature annealing treatment of the touch electrode 7, coating an organic protection film, such as a polyimide (PI) film or a photoresist (PR) film, having a thickness of 3-5 μm to cover the touch electrode 7 in order to protect, in subsequent steps, the touch electrode 7 from scratching.

Step 3: providing an array color-filter substrate 1.

Specifically, the array color-filter substrate 1 combines a function of a thin-film transistor (TFT) array and a filtering function of a color filter and comprises a lower backing plate 11, a gate terminal 121 and a scan line 122 arranged on the lower backing plate 11, a gate insulation layer 13 arranged on the gate terminal 121, the scan line 122, and the lower backing plate 11, an island-like semiconductor layer 14 arranged on the gate insulation layer 13 and located above the gate terminal 121, source/drain terminals 151 arranged on the gate insulation layer 13 and respectively in contact engagement with two opposite side portions of the island-like semiconductor layer 14, a data line 152 arranged on the gate insulation layer 13, an insulation protection layer 16 arranged on the source/drain terminals 151, the data line 152, and the gate insulation layer 13, color filter photoresist 17 arranged on the insulation protection layer 16, a pixel electrode 18 arranged on the color filter photoresist 17 and in contact engagement with a portion of the source/drain terminals 151, an insulation layer 19 arranged on the pixel electrode 18 and the color filter photoresist 17, a comb-like common electrode 20 arranged on the insulation layer 19 and opposite to the pixel electrode 18, a black matrix 21 arranged on the insulation layer 19, a photo spacer 22 arranged on the black matrix 21, and a lower alignment film 23 covering the insulation layer 19, the common electrode 20, the black matrix 21, and the photo spacer 22. The gate terminal 121, the island-like semiconductor layer 14, and the source/drain terminals 151 collectively constitute a thin-film transistor T.

The lower backing plate 11 is a glass plate.

The pixel electrode 18 and the common electrode 20 are preferably each formed of a material of ITO.

The array color-filter substrate 1 is manufactured by applying a deposition technique or a deposition technique and a masking and etching operation that are known to form, in sequence, various structural layers. No further detail will be provided herein.

Step 4: laminating the array color-filter substrate 1 and the upper substrate 3 together in such a way that the upper alignment film 33 faces the array color-filter substrate 1 and filling liquid crystal between the array color-filter substrate 1 and the upper substrate 3 to form a liquid crystal layer 5.

Moreover, Step 4 further comprises removing the organic protection film of Step 2 that covers the touch electrode 7.

To this point, the manufacture of the IPS on-cell touch display panel is completed. Since the touch electrode 7 is formed before the array color-filter substrate 1 and the upper substrate 3 are laminated together and the liquid crystal layer 5 is formed and is subjected to high temperature annealing treatment so that the impedance of the touch electrode 7 is reduced and touch sensitivity is increased.

In summary, the present invention provides an IPS on-cell touch display panel, which comprises an array color-filter substrate that combines a function of a TFT array and a filtering function of a color filter and comprises an upper substrate that comprises only a backing plate and an alignment film with a touch electrode arranged on a surface of the upper backing plate that is distant from a liquid crystal layer and the touch electrode has been subjected to high temperature annealing treatment so that the impedance of the touch electrode is reduced and the touch sensitivity is increased. The present invention provides a manufacturing method of an IPS on-cell touch display panel, in which before an array color-filter substrate and an upper substrate are laminated together and a liquid crystal layer is formed, a touch electrode is first formed on a surface of an upper backing plate of an upper substrate that is distant from the liquid crystal layer and the touch electrode is subjected to high temperature annealing treatment so as to reduce the impedance of the touch electrode and increase the touch sensitivity.

Based on the description given above, those having ordinary skills of the art may easily contemplate various changes and modifications of the technical solution and technical ideas of the present invention and all these changes and modifications are considered within the protection scope of right for the present invention.

What is claimed is:

1. An in-plane switching (IPS) on-cell touch display panel, comprising an array color-filter substrate, an upper substrate opposite to the array color-filter substrate, a liquid crystal layer interposed between the array color-filter substrate and the upper substrate, and a touch electrode arranged on a surface of the upper substrate that is distant from the liquid crystal layer;
the array color-filter substrate comprising a thin-film transistor (TFT), a pixel electrode, a comb-like common electrode, and a color filter photoresist and combining a function of a TFT array and a filtering function of a color filter;
the upper substrate comprising only an upper backing plate and an upper alignment film arranged on a surface of the upper backing plate that is adjacent to the liquid crystal layer;
the touch electrode being arranged on a surface of the upper backing plate that is distant from the liquid crystal layer, the touch electrode being subjected to high temperature annealing treatment.

2. The IPS on-cell touch display panel as claimed in claim 1, wherein the array color-filter substrate comprises a lower backing plate, a gate terminal and a scan line arranged on the lower backing plate, a gate insulation layer arranged on the gate terminal, the scan line, and the lower backing plate, an island-like semiconductor layer arranged on the gate insulation layer and located above the gate terminal, source/drain terminals arranged on the gate insulation layer and respectively in contact engagement with two opposite side portions of the island-like semiconductor layer, a data line arranged on the gate insulation layer, an insulation protection layer arranged on the source/drain terminals, the data line, and the gate insulation layer, color filter photoresist arranged on the insulation protection layer, a pixel electrode arranged on the color filter photoresist and in contact engagement with a portion of the source/drain terminals, an insulation layer arranged on the pixel electrode and the color filter photoresist, a comb-like common electrode arranged on the insulation layer and opposite to the pixel electrode, a black matrix arranged on the insulation layer, a photo spacer arranged on the black matrix, and a lower alignment film covering the insulation layer, the common electrode, the black matrix, and the photo spacer;
the gate terminal, the island-like semiconductor layer, and the source/drain terminals collectively constituting the TFT.

3. The IPS on-cell touch display panel as claimed in claim 1, wherein the touch electrode is formed of a material of indium tin oxide (ITO).

4. The IPS on-cell touch display panel as claimed in claim 1, wherein the pixel electrode and the common electrode are each formed of a material of ITO.

5. The IPS on-cell touch display panel as claimed in claim 2, wherein the upper backing plate and the lower backing plate are each a glass plate.

6. An in-plane switching (IPS) on-cell touch display panel, comprising an array color-filter substrate, an upper substrate opposite to the array color-filter substrate, a liquid crystal layer interposed between the array color-filter substrate and the upper substrate, and a touch electrode arranged on a surface of the upper substrate that is distant from the liquid crystal layer;
the array color-filter substrate comprising a thin-film transistor (TFT), a pixel electrode, a comb-like common electrode, and a color filter photoresist and combining a function of a TFT array and a filtering function of a color filter;
the upper substrate comprising only an upper backing plate and an upper alignment film arranged on a surface of the upper backing plate that is adjacent to the liquid crystal layer;
the touch electrode being arranged on a surface of the upper backing plate that is distant from the liquid crystal layer, the touch electrode being subjected to high temperature annealing treatment;
wherein the array color-filter substrate comprises a lower backing plate, a gate terminal and a scan line arranged on the lower backing plate, a gate insulation layer arranged on the gate terminal, the scan line, and the lower backing plate, an island-like semiconductor layer arranged on the gate insulation layer and located above the gate terminal, source/drain terminals arranged on the gate insulation layer and respectively in contact engagement with two opposite side portions of the island-like semiconductor layer, a data line arranged on the gate insulation layer, an insulation protection layer arranged on the source/drain terminals, the data line, and the gate insulation layer, color filter photoresist arranged on the insulation protection layer, a pixel electrode arranged on the color filter photoresist and in contact engagement with a portion of the source/drain terminals, an insulation layer arranged on the pixel electrode and the color filter photoresist, a comb-like common electrode arranged on the insulation layer and opposite to the pixel electrode, a black matrix arranged on the insulation layer, a photo spacer arranged on the black matrix, and a lower alignment film covering the insulation layer, the common electrode, the black matrix, and the photo spacer;
the gate terminal, the island-like semiconductor layer, and the source/drain terminals collectively constituting the TFT;
wherein the touch electrode is formed of a material of indium tin oxide (ITO); and
wherein the pixel electrode and the common electrode are each formed of a material of ITO.

7. The IPS on-cell touch display panel as claimed in claim 6, wherein the upper backing plate and the lower backing plate are each a glass plate.

8. A manufacturing method of an in-plane switching (IPS) on-cell touch display panel, comprising the following steps:
(1) providing an upper backing plate and coating an alignment solution on a surface of the upper backing plate to form an upper alignment film, thereby forming an upper substrate;
(2) forming a touch electrode on a surface of the upper backing plate that is opposite to the alignment film and subjecting the touch electrode to high temperature annealing treatment so as to reduce impedance of the touch electrode;
(3) providing an array color-filter substrate, wherein the array color-filter substrate comprises a thin-film transistor (TFT), a pixel electrode, a comb-like common electrode, and a color filter photoresist and combines a function of a TFT array and a filtering function of a color filter; and
(4) laminating the array color-filter substrate and the upper substrate together in such a way that the upper alignment film faces the array color-filter substrate and filling liquid crystal between the array color-filter substrate and the upper substrate to form a liquid crystal layer.

9. The manufacturing method of the IPS on-cell touch display panel as claimed in claim 8, wherein step (2) further comprises, after the high temperature annealing treatment of the touch electrode, coating an organic protection film to cover the touch electrode; and
step (4) further comprises removing the organic protection film.

10. The manufacturing method of the IPS on-cell touch display panel as claimed in claim 9, wherein the organic protection film is formed of a material of polyimide or photoresist and has a thickness of 3-5 μm.

11. The manufacturing method of the IPS on-cell touch display panel as claimed in claim 8, wherein the array color-filter substrate comprises a lower backing plate, a gate terminal and a scan line arranged on the lower backing plate, a gate insulation layer arranged on the gate terminal, the scan line, and the lower backing plate, an island-like semiconductor layer arranged on the gate insulation layer and located above the gate terminal, source/drain terminals arranged on the gate insulation layer and respectively in contact engagement with two opposite side portions of the island-like semiconductor layer, a data line arranged on the gate insulation layer, an insulation protection layer arranged on the source/drain terminals, the data line, and the gate insulation layer, color filter photoresist arranged on the insulation protection layer, a pixel electrode arranged on the color filter photoresist and in contact engagement with a portion of the source/drain terminals, an insulation layer arranged on the pixel electrode and the color filter photoresist, a comb-like common electrode arranged on the insulation layer and opposite to the pixel electrode, a black matrix arranged on the insulation layer, a photo spacer arranged on the black matrix, and a lower alignment film covering the insulation layer, the common electrode, the black matrix, and the photo spacer;
the gate terminal, the island-like semiconductor layer, and the source/drain terminals collectively constituting the TFT.

12. The manufacturing method of the IPS on-cell touch display panel as claimed in claim 11, wherein the touch electrode, the pixel electrode, and the common electrode are each formed of a material of indium tin oxide (ITO); and the upper backing plate and the lower backing plate are each a glass plate.
